(19) United States
(12) Patent Application Publication
(10) Pub. No.: US 2004/0211325 A1
(43) Pub. Date: Oct. 28, 2004

(54) Uniformly heatable rollers for a roller grill assembly

(75) Inventor: Richard L. Poland, Cranford, NJ (US)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Creative Serving Incorporated, Union, NJ (US)

(21) Appl. No.: 10/423,401

(22) Filed: Apr. 25, 2003

(51) Int. Cl. A23P 1/00; A47J 43/18

(52) U.S. Cl. 99/441; 99/427

(57) ABSTRACT

A roller grill assembly includes a roller grill housing and a plurality of rollers disposed in an array and rotatably supported by the housing, each roller having an external heating surface, a first opening at a first end thereof and a second opening at a second end thereof. The roller grill assembly also desirably includes heating elements provided in the rollers for heating the external heating surfaces, and a first insulating end cap secured in the first opening of each roller and a second insulating end cap secured in the second opening of each roller for minimizing heat loss through the ends of the rollers.

### BACKGROUND OF THE INVENTION

The present invention is generally related to cooking units and is more specifically related to roller grill assemblies.

Roller grill assemblies typically use an array of heatable tubes that are rotatably mounted within a grill housing. In operation, food items are placed upon the roller tubes and the roller tubes are rotated as heat is transferred to the food items.

There have been many improvements in roller grill assembly technology. Some of these improvements are directed to providing uniform heat temperature levels across the width of the roller tubes. For example, FIG. 1 of U.S. Pat. No. 6,393,971 to Hunot et al. shows a roller grill assembly 20 including a main housing 24, rotatable roller tubes 26 including two heating members 28, and roller tube drive assembly 32. Referring to FIG. 8 thereof, the assembly includes cover plates 217 that serve to reflect heat emanating from the tube ends 194 for uniform heat levels near the ends of the tubes 194. As shown in FIG. 13 of the '971 patent, the spacing between each of the heating elements 222 is more compact at the outer sections 224, 226 thereof, than in the central part 228. The more compact spacing between the windings in sections 224 and 226 provide for greater wattage and more intense heating at the ends of the roller tubes 26, than for the interior regions of the roller tube positioned around the less compact portion of the coils 228.

U.S. Pat. No. 6,486,448 to Niskanen et al. discloses a method for heating a roll. Instead of heating the roll using a circulating liquid, Niskanen teaches introducing heat at a position very close to the outer surface of the roll mantle for reducing thermal stress, whereby the temperature profile of the roll can be kept substantially more uniform than in rollers heated by a circulating liquid. As a result, large temperature gradients across the roll are eliminated.

U.S. Pat. No. 6,349,634 to Delpierre III et al. discloses a grill with improved rotary heating elements. Referring to FIG. 1 thereof, the grill 10 includes a plurality of rollers 12 which are rotatably supported by side walls 14. Each roller has a generally cylindrical exterior surface and at least one internal heating element 16 thermally coupled to the exterior surface of the roller. Referring to FIG. 2 of the '634 patent, wires 30 are fixed to the roller 20 in a helical grid pattern along the length of the cylindrical roller. The wires 30 may be anchored by binding them to rings 24 that extend around the roller at each end of the grid. Referring to FIG. 3, a grid is provided by longitudinal wire segments 32 and circumferential wire segments 34. The wire grid is preferably in direct contact with the roller for transmitting heat to the roller.

In spite of the above advances, there remains a need for a roller grill assembly having uniformly heatable rollers, whereby the temperature at the exterior heating surface of the rollers is substantially uniform across the width of the rollers.

### SUMMARY OF THE INVENTION

In certain preferred embodiments of the present invention, a roller grill assembly includes a plurality of rollers disposed in an array, each roller having an external heating surface, a first opening at a first end of the roller and a second opening at a second end of the roller. The roller grill assembly also preferably includes a heating element provided in each roller for heating the external surface, a first insulating end cap in communication with the first opening of each roller and a second insulating end cap in communication with the second opening of each roller, whereby the insulating end caps minimize heat loss through the openings at the ends of the rollers by preventing heat from escaping through the ends.

In some preferred embodiments, the first insulating end caps cover the first openings of the rollers and the second insulating end caps cover the second openings of the rollers. In other preferred embodiments, the first insulating end caps are secured over the first openings of the rollers and the second insulating end caps are secured over the second openings of the rollers. In highly preferred embodiments, the first insulating end caps are integrally connected with the first openings of the rollers and the second insulating end caps are integrally connected with the second openings of the rollers, such as by welding.

In other preferred embodiments, at least one of the insulating end caps preferably has a central opening and the heating element passes through the central opening. In more preferred embodiments, each of the insulating end caps has a central opening, whereby the heating elements pass through the central openings. In operation, the heating element transfers heat to the exterior surface of the roller tube which, in turn, transfer heat to the food items in contact with the exterior surface of the roller tube.

The assembly may also include a sprocket connected with each of the first insulating end caps, and a drive element engagable with the sprocket for rotating the first insulating end caps and the rollers. The sprocket and the insulating end cap may be one piece or may be integrally connected with one another. The drive element and the sprocket are desirably arranged for rotating the rollers in the same rotational direction. In highly preferred embodiments, the drive element is a drive chain.

Each roller preferably has the shape of a substantially cylindrical tube. The rollers are desirably made of a heat conductive material such as metal. Preferred rollers are made of stainless steel and cold rolled steel. Preferred finishes applied over the exterior surfaces of the rollers include chrome plated finishes and non-stick finishes.

The roller grill assembly also desirably includes supports in contact with the first and second ends of the rollers for rotatably supporting the rollers. The assembly desirably includes a roller grill housing, whereby the supports are secured to the housing for rotatably supporting the rollers.

The roller grill assembly may also include a sneeze guard secured over the roller grill housing. The sneeze guard is preferably at least partially transparent and made of a polymeric material and includes at least one opening for accessing food product being heated on the rollers. The sneeze guard may also include an elongated slot formed in a top surface of the sneeze guard that is adapted to receive a bottom edge of signage, such as an advertisement or menu board.

In other preferred embodiments of the present invention, a roller grill assembly includes a roller grill housing and at least one roller rotatably mounted in the housing. The at least one roller has an external heating surface, a first opening at a first end of the roller, a second opening at a second end of the roller, and a heating element provided in the roller for heating the external surface of the roller. The roller grill assembly also desirably includes a first insulating end cap in communication with the first opening of the roller and a second insulating end cap in communication with the second opening of the roller, whereby the insulating end caps minimize heat loss through the openings at the ends of the roller. A sprocket may be connected with the first insulating end cap, and a drive element is desirably engagable with the sprocket for rotating the first insulating end cap and the roller. In other preferred embodiments, the sprocket may be provided at either end of the roller.

In still other preferred embodiments of the present invention, a roller grill assembly includes a roller grill housing, and a plurality of rollers disposed in an array and rotatably supported by the housing, each roller having an external heating surface, a first opening at a first end of each roller and a second opening at a second end of each roller. The roller grill assembly also desirably includes heating elements provided in the rollers for heating the external heating surfaces, a first insulating end cap secured in the first opening of each roller and a second insulating end cap secured in the second opening of each roller, whereby the insulating end caps minimize heat loss through the ends of the rollers. The assembly may also include drive sprockets having teeth connected with each of the first insulating end caps, and a drive element engagable with the drive sprockets for rotating the first insulating end caps and the rollers. The drive sprockets and the insulating end caps may be integrally connected with one another.

These and other preferred embodiments of the present invention will be described in more detail below.

### BRIEF DESCRIPTION OF THE DRAWINGS

FIG. 1 shows a perspective view of a roller grill assembly including a plurality of heatable rollers, in accordance with certain preferred embodiments of the present invention.

FIG. 2 shows an end view of one of the heatable rollers of FIG. 1.

FIG. 3 shows an insulating end cap for covering the end of the roller of FIG. 2, in accordance with certain preferred embodiments of the present invention.

FIG. 4 shows the insulating end cap of FIG. 3 covering the end of the heatable roller of FIG. 2.

FIG. 5 shows a front elevation view of a heatable roller for the roller grill assembly of FIG. 1 including an insulating end caps secured over open ends thereof, a support element and a heating element.

FIG. 6 shows an insulating end cap for an open end of a heatable roller, in accordance with other preferred embodiments of the present invention.

FIG. 7 shows an open end of a heatable roller.

FIG. 8 shows the insulating end cap of FIG. 6 secured over the open end of the roller of FIG. 7.

FIG. 9 shows a front elevation view of the heatable roller of FIG. 8 including the insulating end cap.

FIG. 10 shows a series of heatable roller tubes including insulating end caps having sprockets engaged with a driving element, in accordance with certain preferred embodiments of the present invention.

FIG. 11 shows a front elevation view of a roller tube including a first insulating end cap at a first end and a second insulating end cap including a sprocket at a second end, in accordance with further preferred embodiments of the present invention.

FIG. 12 shows a detailed view of the first end of the roller tube of FIG. 11.

FIG. 13 shows a perspective view of the second end of the roller tube of FIG. 11 including a cut-away view of the second insulating end cap with sprockets.

FIG. 14 shows a cut-away view of the second end of the roller tube of FIG. 13.

FIG. 15 shows a front view of the second insulating end cap shown in FIG. 11.

### DETAILED DESCRIPTION

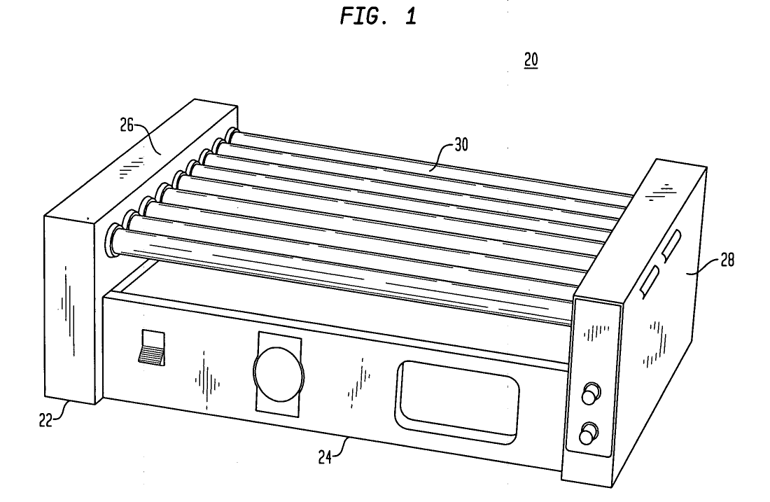

FIG. 1 shows a roller grill assembly 20 including a housing 22 having a front control panel 24, a left support 26 and an opposing right support 28. The roller grill assembly 20 includes an array of heatable rollers 30 rotatably mounted in the left and right supports 26, 28. The heatable rollers 30 are rotatable and are preferably rotatable in the same direction. In operation, the heatable rollers 30 transmit heat to food items placed atop the rollers.

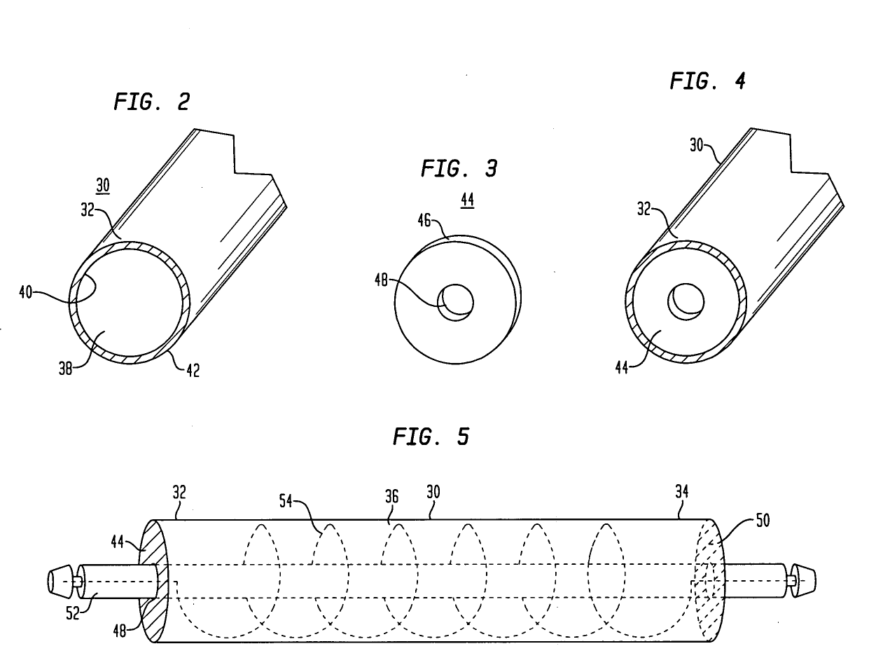

Referring to FIGS. 2 and 5, each heatable roller 30 preferably has a first end 32, a second end 34 and an intermediate region 36 between the first and second ends 32, 34. Each end of the heatable roller tube 30 desirably has an opening at the ends 32, 34 thereof.

Referring to FIG. 2, the roller tube 30 has a first opening 38 at the first end 32 thereof. The roller tube includes an interior surface 40 and an exterior surface 42 opposite the interior surface 40.

Referring to FIG. 3, an insulating end cap 44 insertable into the opening at the first end of the roller tube 30 includes an outer perimeter 46 and a central opening 48.

Referring to FIG. 4, in certain preferred embodiments, the insulating end cap 44 covers the opening at the first end 32 of roller tube 30. As will be described in more detail below, the insulating end cap 44 preferably minimizes the amount of heat that may escape through the ends of roller tube 30 so as to provide for more uniform heating of the roller tube 30 across the width of the roller tube.

Referring to FIG. 5, a first insulating end cap 44 covers the opening at the first end 32 of roller tube 30 and a second insulating end cap 50 covers the opening at the second end 34 of the roller tube 30. Roller tube 30 is in engagement with a supporting element 52 that passes through the central opening 48 of first insulating end cap 44, as well as the central opening (not shown) of second insulating end cap 50. The roller tube 30 also has a heating element which passes through the central openings of the first and second insulating end caps 44, 50. The heating element 54 may be wound around the interior surface 40 (FIG. 2) of the roller tube 30 in a helical pattern for transmitting heat to the exterior surface 33 of the roller tube 30. In other preferred embodiments, the heating element 54 may pass directly through the center of the roller tube and emanate heat outwardly therefrom.

Although the present invention is not limited by any particular theory of operation, it is believed that the insulating end caps minimize the amount of heat that may escape or leak through the open ends of the roller tubes. As a result, the heat will tend to remain within the roller tube and more uniformly heat the exterior surface of the roller tube 30. As noted above in the discussion of prior art roller grill assemblies, roller tubes having open ends allow heat to escape, so that the outer ends of the roller tubes have lower temperatures than the inner ends. As a result, any food product positioned over the outer ends of the roller tubes will not be heated to the same temperature as the food product positioned over the inner regions of the roller tubes.

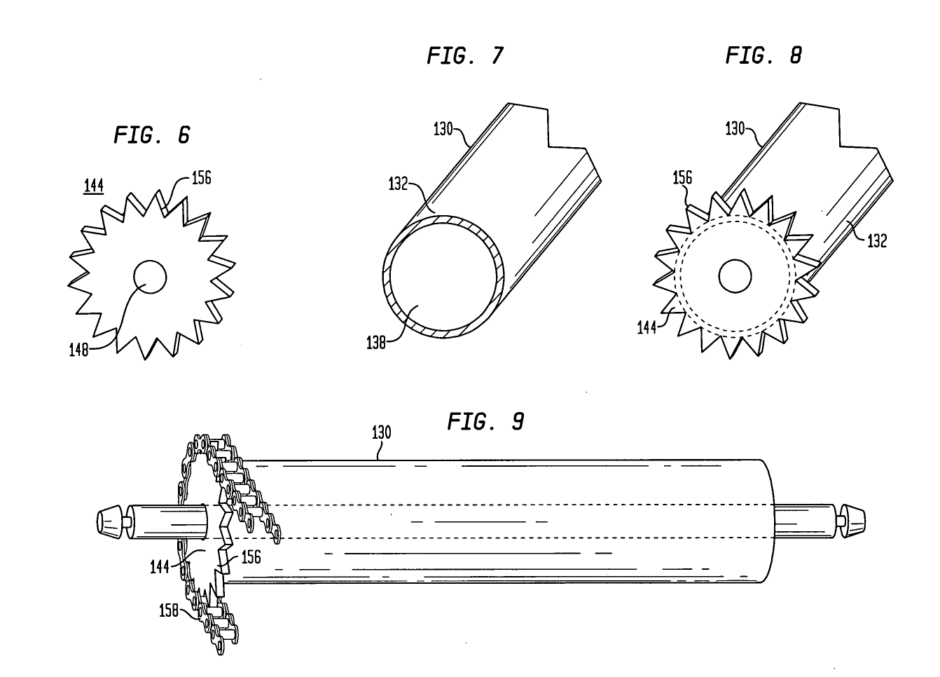

FIGS. 6-9 show a roller tube for a roller grill assembly in accordance with other preferred embodiments of the present invention. Referring to FIG. 6, insulating end cap 144 has a central opening 148 and sprockets 156 on an outer perimeter thereof. The insulating end cap 144 is preferably made stainless steel or cold rolled steel, drawn cold rolled steel or drawn stainless steel.

Referring to FIGS. 7 and 8, roller tube 130 has an opening 138 at the first end 132 thereof. The insulating end cap 144 is secured over the first opening 138 for at least partially covering the opening at the first end 132 of roller tube 130. Referring to FIGS. 8 and 9, the sprockets 156 of the insulating end cap 144 are engagable with a drive element 158, such as a drive train, for rotating the insulating end cap 148. Rotation of the insulating end cap 148, in turn, rotates the roller tube 130.

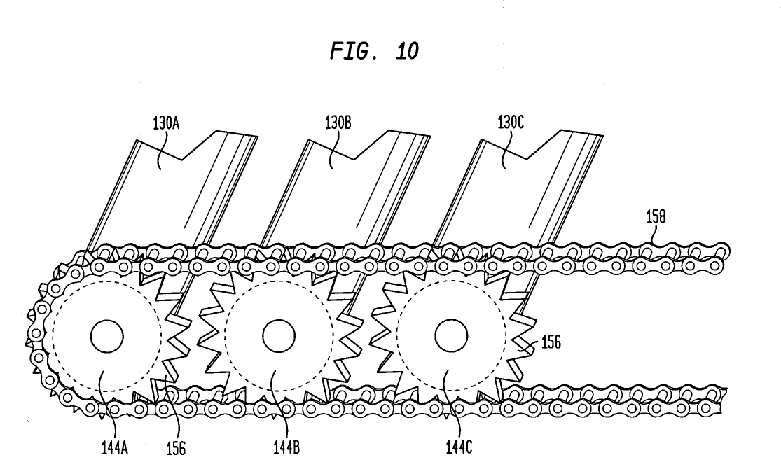

Referring to FIG. 10, the drive element 158 is in engagement with the respective sprockets 156 of a series of insulating end caps 144A, 144B, 144C for rotating the insulating end caps, which, in turn, rotate the respective roller tubes 130A, 130B and 130C. The engagement of the sprockets with the drive element 158 insures that all of the roller tubes 130A-130C rotate in the same direction for rotating food product positioned thereon.

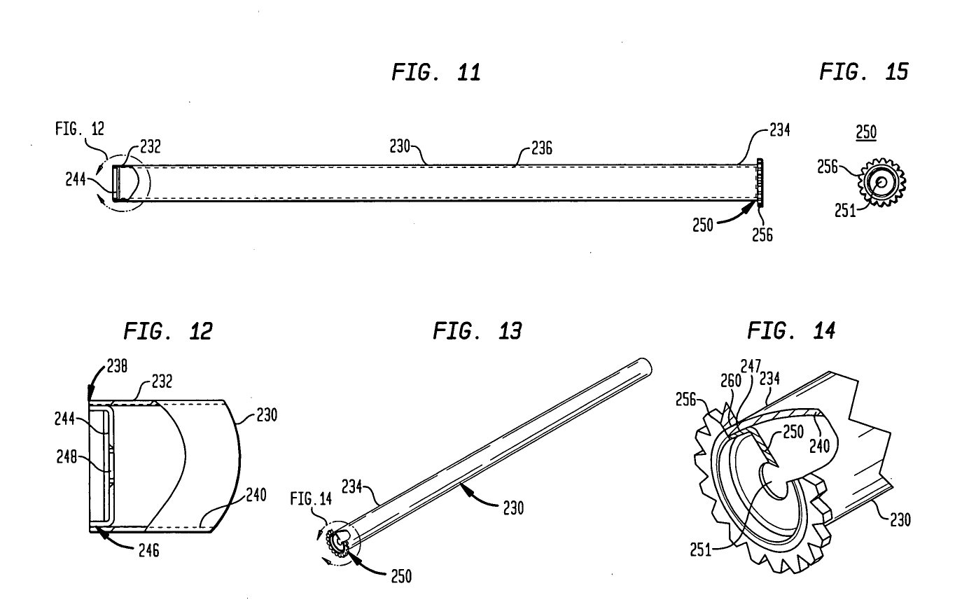

FIG. 11 shows a roller tube 230 in accordance with another preferred embodiment of the present invention including first end 232, second end 234 and intermediate region 236. A first insulating end cap 244 covers an opening at first end 232 of roller 230. In addition, a second insulating end cap 250 with sprockets 256 covers an opening at the second end 234 of roller 230.

FIG. 12 shows a detailed view of the first end of the roller tube 230 having an opening 238 at the first end 232 thereof, first insulating end cap 244 having a sealing flange 246 and a central opening 248 secured within the first opening 238. The sealing flange 246 is preferably welded to the interior surface 240 of roller tube 230.

FIG. 13 shows roller tube 230 having second insulating end cap 250 secured to the opening at the second end 234 thereof. Referring to FIG. 14, second insulating end cap 250 includes central opening 251 and sprockets 256. The second insulating end cap 250 is secured within an opening at the second end 234 of roller tube 230.

FIG. 15 shows a front view of the second insulating end cap 250 having central opening 251 and sprockets 256. As shown in FIG. 14, the second insulating end cap 250 is assembled with the second end 234 of roller tube 230. The second insulating end cap preferably includes a sealing flange 247 that is welded to the interior surface 240 of roller tube 230. In certain preferred embodiments, the number of teeth on the sprocket is approximately 15-20 evenly spaced around the perimeter of the second insulating end cap 250. As noted above, the teeth of the sprocket are engagable with a drive element such as a drive chain for rotating the sprocket in second insulating end cap 250, which, in turn, rotates the roller tube 230.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. A roller grill assembly comprising:
a plurality of rollers disposed in an array, each said roller having an external heating surface, a first opening at a first end of said roller and a second opening at a second end of said roller;
a heating element provided in each said roller for heating the external surface thereof;
a first insulating end cap in communication with the first opening of each said roller and a second insulating end cap in communication with the second opening of each said roller, wherein said insulating end caps minimize heat loss through the openings at the ends of said rollers.

2. The roller grill assembly as claimed in claim 1, wherein said first insulating end caps cover the first openings of said rollers and said second insulating end caps cover the second openings of said rollers.

3. The roller grill assembly as claimed in claim 1, wherein said first insulating end caps are secured over the first openings of said rollers and said second insulating end caps are secured over the second openings of said rollers.

4. The roller grill assembly as claimed in claim 3, wherein said first insulating end caps are integrally connected with the first openings of said rollers and said second insulating end caps are integrally connected with the second openings of said rollers.

5. The roller grill assembly as claimed in claim 4, further comprising:
a sprocket connected with each of said first insulating end caps; and
a drive element engagable with said sprockets for rotating said first insulating end caps and said rollers.

6. The roller grill assembly as claimed in claim 5, wherein said drive element and said sprockets are arranged for rotating said rollers in the same rotational direction.

7. The roller grill assembly as claimed in claim 6, wherein said drive element is a drive chain.

8. The roller grill assembly as claimed in claim 1, wherein each said roller is a cylindrical tube.

9. The roller grill assembly as claimed in claim 1, wherein each said roller is made of metal.

10. The roller grill assembly as claimed in claim 9, wherein said metal is selected from the group consisting of stainless steel and cold rolled steel.

11. The roller grill assembly as claimed in 9, wherein a finish is applied over the external heating surfaces of said rollers, said finish being selected from the group consisting of a chrome plated finish and a non-stick finish.

12. The roller grill assembly as claimed in claim 1, wherein at least one of said insulating end caps has a central opening and said heating element passes through the central opening.

13. The roller grill assembly as claimed in claim 1, further comprising supports in contact with the first and second ends of said rollers for rotatably supporting said rollers.

14. The roller grill assembly as claimed in claim 13, further comprising a roller grill housing, wherein said supports are secured to said housing for rotatably supporting said rollers.

15. The roller grill assembly as claimed in claim 14, further comprising a sneeze guard secured over said roller grill housing, said sneeze guard including at least one opening for accessing food product being heated on said rollers, said sneeze guard including an elongated slot formed in a top surface thereof adapted to receive a bottom edge of signage.

16. A roller grill assembly comprising:
a roller grill housing;
at least one roller rotatably mounted in said housing, said roller having an external heating surface, a first opening at a first end of said roller and a second opening at a second end of said roller;
a heating element provided in said roller for heating the external surface of said roller;
a first insulating end cap in communication with the first opening of said roller and a second insulating end cap in communication with the second opening of said roller, wherein said insulating end caps minimize heat loss through the openings at the first and second ends of said roller.

17. The roller grill assembly as claimed in claim 16, further comprising:
a sprocket connected with said first insulating end cap;
a drive element engagable with said sprocket for rotating said first insulating end cap and said roller.

18. A roller grill assembly comprising:
a roller grill housing;
a plurality of rollers disposed in an array and rotatably supported by said housing, each said roller having an external heating surface, a first opening at a first end of each said roller and a second opening at a second end of each said roller;
heating elements provided in said rollers for heating the external heating surfaces;
a first insulating end cap secured in the first opening of each said roller and a second insulating end cap secured in the second opening of each said roller, wherein said insulating end caps minimize heat loss through the ends of said rollers.

19. The roller grill assembly as claimed in claim 18, further comprising:
drive sprockets connected with each of said first insulating end caps;
a drive element engagable with said drive sprockets for rotating said first insulating end caps and said rollers.

20. The roller grill assembly as claimed in claim 19, wherein each said first insulating end cap has a central opening and said heating elements pass through said central openings.

21. The roller grill assembly as claimed in claim 19, further comprising supports secured -to said housing, the first and second ends of said rollers being rotatably mounted in said supports.
